(19) United States
(12) Patent Application Publication
(10) Pub. No.: US 2010/0246162 A1
(43) Pub. Date: Sep. 30, 2010

(54) LAMP SOCKET AND DISPLAY DEVICE HAVING THE SAME

(76) Inventors: Joo-Woan Cho, Asan-si (KR); Seong-Sik Choi, Seoul (KR); Yong-Woo Lee, Suwon-si (KR)

Correspondence Address: Innovation Counsel LLP, 21771 Stevens Creek Blvd, Ste. 200A, Cupertino, CA, 95014, US

(21) Appl. No.: 12/706,666

(22) Filed: Feb. 16, 2010

(30) Foreign Application Priority Data
Mar. 24, 2009 (KR) 10-2009-0024982

(51) Int. Cl. G02F 1/13357; F21V 21/08

(52) U.S. Cl. 362/97.1; 362/396

(57) ABSTRACT

A lamp socket formed to facilitate the performance of a lamp assembly, and a display device having the lamp socket, are provided. The lamp socket includes a holding portion mounted on a board, and a terminal portion bent from the holding portion and having a lamp insertion hole into which a lamp is securely inserted, wherein the lamp insertion hole is formed through the terminal portion and has a cross-sectional width gradually decreasing toward a lower portion of the terminal portion.

### CROSS-REFERENCE TO RELATED APPLICATION

This application claims priority from Korean Patent Application No. 10-2009-0024982 filed on Mar. 24, 2009 in the Korean Intellectual Property Office, the disclosure of which is incorporated herein by reference in its entirety.

### BACKGROUND OF THE INVENTION

1. Field of the Invention

The present invention relates to a lamp socket and a display device having the same, and more particularly, to a lamp socket constructed to facilitate the performance of the lamp assembly, and a display device having the lamp socket.

2. Description of the Related Art

A liquid crystal display is one form of a flat panel display that is now widely used. Typically, the liquid crystal display includes two panels (e.g., upper and lower panels) in which field generating electrodes, such as pixel electrodes and common electrodes, are formed, with a liquid crystal layer interposed between the panels. During operation of the liquid crystal display, a voltage is applied to the field generating electrodes to generate an electric field in the liquid crystal layer, which controls the direction of liquid crystal molecules of the liquid crystal layer based on the generated electric field, and an image is displayed by controlling the polarization of an incident light.

Since the LCD cannot emit light by itself, it may require a backlight assembly including a light source for supplying light thereto to display an image. The backlight assembly irradiates light from a rear side of a display panel and serves as a surface light source for providing uniform light throughout the display panel. Depending on the location of the light source for supplying light to the display panel, the backlight assembly may be classified as either an edge-type backlight assembly or a direct-type backlight assembly. The direct-type backlight assembly is provided with a light source directly below the display panel, while the edge-type backlight assembly is provided with a light source at a lateral side of a display panel, to transmit light throughout the panel using a light guiding plate.

The performance of the light source assembly, which is an essential component of a display device, significantly affects the production efficiency of the display device. Accordingly, it is necessary to develop a lamp socket capable of enhancing the performance of the light source assembly.

### SUMMARY OF THE INVENTION

The present invention provides a lamp socket constructed to facilitate the performance of a lamp assembly.

The present invention also provides a display device having a lamp socket constructed to facilitate the performance of a lamp assembly.

These and other objects of the present invention will be described in or be apparent from the following description of the preferred embodiments.

According to an aspect of the present invention, there is provided a lamp socket including a holding portion mounted on a board, and a terminal portion bent from the holding portion and having a lamp insertion hole into which a lamp is inserted, wherein the lamp insertion hole is formed through the terminal portion and has a cross-sectional width gradually decreasing toward a lower portion of the terminal portion.

According to another aspect of the present invention, there is provided a display device including a backlight assembly including a board; a lamp socket including a holding portion mounted on the board, and a terminal portion bent from the holding portion and having a lamp insertion hole; and a lamp inserted into the lamp insertion hole, and a display panel receiving light from the lamp to display an image. The lamp insertion hole is formed through the terminal portion, and has a cross-sectional width gradually decreasing toward a lower portion of the terminal portion.

### BRIEF DESCRIPTION OF THE DRAWINGS

The above and other features and advantages of the present invention will become more apparent by describing in detail preferred embodiments thereof with reference to the attached drawings, in which:

FIG. 1 is an exploded perspective view illustrating a display device according to a first exemplary embodiment of the present invention;

FIG. 2 is an exploded perspective view illustrating a lamp socket and a substrate included in the display device shown in FIG. 1;

FIG. 3 is a front view illustrating the lamp socket in FIG. 2;

FIG. 4 is a side view illustrating the lamp socket in FIG. 2;

FIGS. 5A through 6B are a perspective view and a cross-sectional view illustrating a process of inserting a lamp into a lamp socket;

FIG. 7 is a partly cut-away view of the lamp included in the display device as shown in FIG. 1;

FIG. 8 is an exploded perspective view illustrating a lamp socket and a substrate included in a display device according to a second exemplary embodiment of the present invention;

FIG. 9 is an exploded perspective view illustrating a lamp socket and a substrate included in a display device according to a third exemplary embodiment of the present invention;

FIG. 10 is a side view illustrating the lamp socket in FIG. 9;

FIG. 11 is an exploded perspective view illustrating a lamp socket and a substrate included in a display device according to a fourth exemplary embodiment of the present invention;

FIG. 12 is a side view illustrating the lamp socket in FIG. 11;

FIG. 13 is a side view illustrating a lamp socket and a substrate included in a display device according to a fifth exemplary embodiment of the present invention;

FIG. 14 is a side view illustrating a lamp socket and a substrate included in a display device according to a sixth exemplary embodiment of the present invention; and

FIG. 15 is a perspective view illustrating a lamp socket and a substrate included in a display device according to a seventh exemplary embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

It will be understood that when an element or layer is referred to as being “on” another element or layer, it can be directly on the other element or layer or intervening elements or layers may be present. In contrast, when an element is referred to as being “directly on” another element or layer, there are no intervening elements or layers present. Like numbers refer to like elements throughout.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures.

Hereinafter, exemplary embodiments of the present invention will be explained in detail with reference to the accompanying drawings.

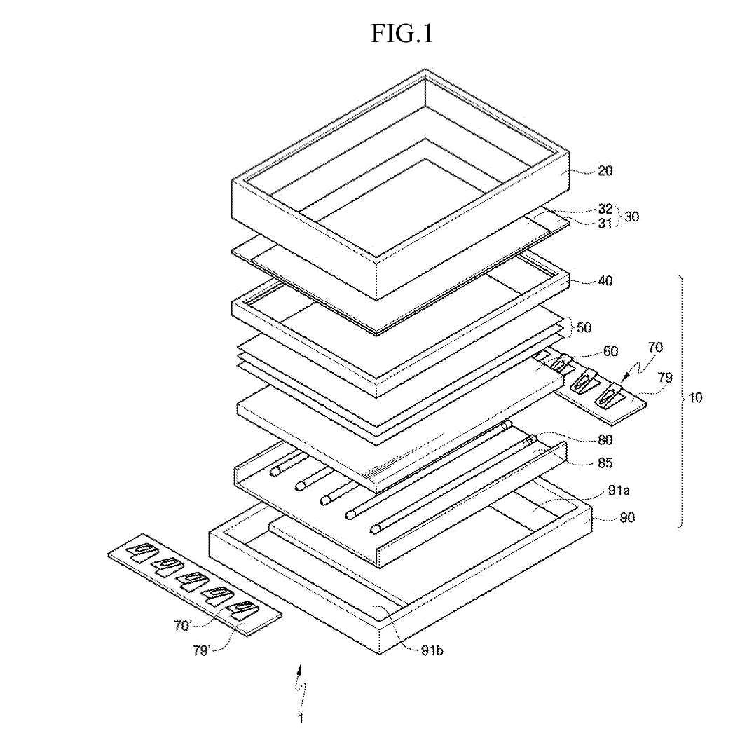

Hereinafter, a display device according to a first exemplary embodiment of the present invention will be described in detail with reference to FIGS. 1 through 7.

FIG. 1 is an exploded perspective view illustrating a display device according to a first exemplary embodiment of the present invention.

Referring to FIG. 1, the display device 1 includes a display panel 30, a top receiving container 20 and a backlight assembly 10. The backlight assembly 10 includes a middle frame 40, optical sheets 50, a diffusion plate 60, lamps 80, a lamp socket 70, a reflective plate 85, and a bottom receiving container 90.

The display panel 30 includes a lower display panel 31 and an upper display panel 32 facing the lower display panel 31. The lower display panel 31 includes gate lines (not shown), data lines (not shown), a thin film transistor (“TFT”) array, and pixel electrodes. The upper display panel 32 includes black matrixes, and a common electrode. The aforementioned display panel 30 receives light from the lamps 80 and displays image information.

The top receiving container 20 forms an external frame of the display device 1, and has a space for receiving the display panel 30. A window is formed on a central portion of the top receiving container 20 to expose the display panel 30 to the outside.

The top receiving container 20 is combined with the bottom receiving container 90. If necessary, the middle frame 40 for receiving the display panel 30 and optical sheets 50 may be disposed between the top receiving container 20 and the bottom receiving container 90.

The optical sheets 50 diffuse and focus the light transmitted from the diffusion plate 60, and are disposed on the diffusion plate 60 to be received within the top receiving container 20 and the bottom receiving container 90. The optical sheets 50 include a first prism sheet, a second prism sheet, and a protective sheet.

The first and second prism sheets focus light incident upon the display panel at a shallow incident angle, to come out in a direction substantially perpendicular to the display panel, by refracting the light diffused by the diffusion plate 60. Thus, the first and second prism sheets enhance the brightness of the display device 1 within the range of an effective viewing angle.

The protective sheet formed on the first and second prism sheets serves to protect surfaces of the prism sheets and diffuse the light to increase the uniformity of light distribution. The configuration of the optical sheets 50 is not limited to the illustrated exemplary embodiment and may be modified in various ways, according to the specification of the display device 1.

The diffusion plate 60 diffuses the light from the lamps 80 in all directions. Diffusing light prevents bright lines corresponding to the shapes of the lamps 80, from being viewed on the front surface of the display device 1.

Cold cathode fluorescent lamps (CCFLs), or hot cathode fluorescent lamps (HCFLs) may be used as the lamps 80. Each of the HCFLs may include two terminals at its opposite ends. The terminals are inserted into the lamp socket 70, 70′ to receive power. Meanwhile, the lamp sockets 70 and 70′ are mounted on boards 79 and 79′, respectively. Inverter circuits for supplying power to the lamps 80 may be mounted on the board 79, 79′. A printed circuit board may be used as the board 79, 79′, and a method of inserting the lamp socket 70, 70′ may include surface mounted technology (SMT). The lamp sockets 70 and 70′ may be provided at opposite ends of each of the lamps 80 to then be inserted into board insertion grooves 91a and 91b, formed on a bottom surface of the bottom receiving container 90. Here, insulating pads (not shown) may be interposed between the boards 79 and 79′ and the bottom receiving container 90.

The reflective sheet 85, disposed below the lamps 80, upwardly reflects the light directed downward from the lamps 80. The reflective sheet 85 reduces loss of light and enhances uniformity of light incident into the display panel 30. The reflective sheet 85 may comprise a separately inserted sheet. In an alternative embodiment, the reflective sheet 85 may comprise a reflective pattern formed by coating highly reflective material on the bottom receiving container 90, instead of the separately inserted sheet. The reflective sheet 85 may be separately inserted into the bottom receiving container 90 along the divided bottom receiving container 90.

The reflective sheet 85 may be bent along sidewalls of the bottom receiving container 90.

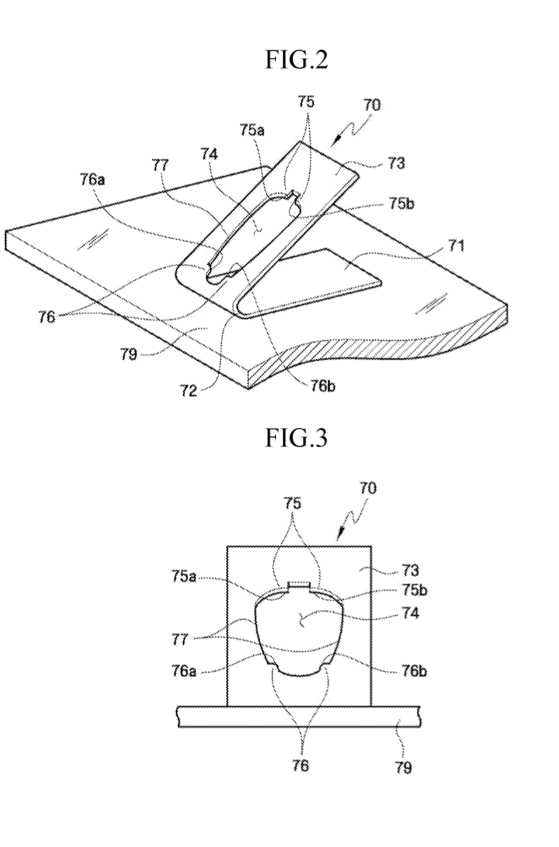

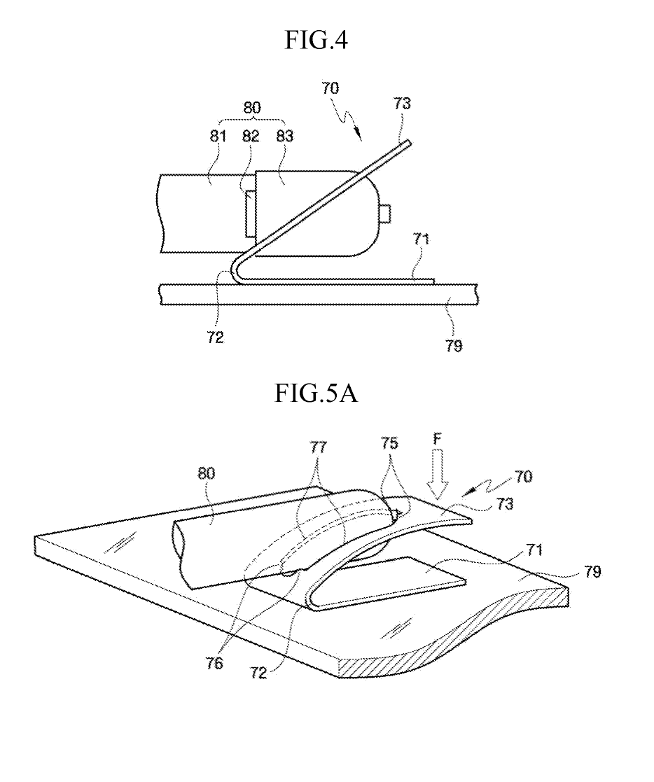

Next, the lamp socket 70 will be described with reference to FIGS. 2 through 4. FIG. 2 is an exploded perspective view illustrating a lamp socket and a substrate included in the display device shown in FIG. 1, FIG. 3 is a front view illustrating the lamp socket in FIG. 2, and FIG. 4 is a side view illustrating the lamp socket in FIG. 2.

The lamp socket 70 fastens the lamps 80 and supplies the lamps 80 with power. The lamp socket 70 includes a holding portion 71, a terminal portion 73, an elastic portion 72, a lamp insertion hole 74, a first support portion 75, and a second support portion 76. In addition, a pair of first fixing protrusions 75a and 75b may be included in the first support portion 75, and a pair of fixing protrusions 76a and 76b may be included in the second support portion 76.

The lamp socket 70 is mounted on a board 79. The board 79 may be a printed circuit board having conductive patterns (not shown), and may be separately formed at opposite ends of the lamp 80, so that the lamp socket 70 positioned at opposite ends of the lamp 80 can be mounted. As described above, an inverter circuit for supplying the lamps 80 with power, or a balance circuit for stabilizing power of the lamps 80, may be mounted on the board 79. Here, the balance circuit may include a balance coil (not shown) for supplying the lamps 80 with a uniform amount of power, or a capacitor (not shown).

The lamp socket 70 may be made of a conductive material, such as a metal. The holding portion 71, the terminal portion 73, the elastic portion 72, the first support portions 75, and the second support portions 76 may be integrally formed. That is to say, the holding portion 71, the terminal portion 73, the elastic portion 72, the first support portions 75, and the second support portions 76 may be formed of a single metal sheet, using a metal sheet machine.

The terminal portion 73 is connected to a lamp electrode 82 formed at one end of each of the lamps 80, and supplies the lamps 80 with power (cf. FIG. 4). A lamp insertion hole 74 into which the lamp 80 is inserted to then be fixed is formed at the terminal portion 73. The terminal portion 73, having the lamps 80 securely inserted, is connected to the holding portion 71 by the elastic portion 72.

The holding portion 71 physically supports the terminal portion 73, and supplies the terminal portion 73 with power. That is to say, the holding portion 71 is mounted on the board 79 to be in direct contact with the board 79, so that the power applied from the board 79 to the lamps 80 is transmitted to the lamps 80 via the holding portion 71, the elastic portion 72 and the terminal portion 73.

The holding portion 71 securely supports lamps 80, and may be formed to have a width greater than a diameter of the lamp 80, thereby increasing a contact area with respect to the board 79. The width of the holding portion 71 may be in a range of about 5 to 10 mm. For example, when the lamp 80 has a diameter of 4 mm, the width of the holding portion 71 may be about 7 mm.

The holding portion 71 is connected to the terminal portion 73 through the elastic portion 72. Here, the holding portion 71 and the terminal portion 73 may be bent, forming an acute angle therebetween.

The angle formed between the holding portion 71 and the terminal portion 73 may be further reduced by an external force. If the external force is removed, the holding portion 71 and the terminal portion 73 may be restored into their original positions. In detail, the elastic portion 72, which is curved, may be formed between the holding portion 71 and the terminal portion 73. The elastic portion 72 may be formed of a metal sheet made of the same material as the holding portion 71 and the terminal portion 73. In addition, the elastic portion 72 may be formed to have a curved surface having an appropriate curvature so as to have a predetermined magnitude of elasticity, as needed.

The elastic portion 72 is a type of a plate spring. When an external force is applied to the terminal portion 73, the elastic portion 72 deforms and stores the deformation energy. Then, when the external force is removed, the terminal portion 73 is restored into its original position by releasing the deformation energy stored in elastic portion 72. As described above, the elastic portion 72 may be integrally formed with the holding portion 71 and the terminal portion 73, and when an external force is applied to the terminal portion 73, not only the elastic portion 72 but also the terminal portion 73 and the holding portion 71 may deform like the plate spring.

The elastic portion 72 may have various shapes in consideration of the magnitude of the external force applied to the terminal portion 73, or the magnitude of the deformation of the terminal portion 73.

The terminal portion 73 includes a lamp insertion hole 74 into which the lamp 80 is inserted. The lamp insertion hole 74 is formed from a perforated central area of the terminal portion 73, and one end of the lamp 80 is inserted into the lamp insertion hole 74. Here, a conductive coating portion 83 of the lamp 80 may directly contact the lamp insertion hole 74.

The lamp insertion hole 74 forms a closed curve having a cross-sectional width gradually decreasing toward the holding portion 71. The lamp insertion hole 74 is formed at an angle with respect to the holding portion 71, tilted along a slanting surface of the terminal portion 73, relative to the holding portion 71. Accordingly, the lamp 80 inserted in parallel with the holding portion 71, is obliquely inserted into the lamp insertion hole 74. Thus, a section of the lamp 80 cut in parallel with a surface of the terminal portion 73 has an oval shape.

The lamp insertion hole 74 is defined by the first support portion 75, the second support portion 76 and a pair of slanting portions 77, by which the lamp insertion hole 74 is encircled (cf. FIGS. 2 and 3). In detail, the second support portion 76 is formed to be closest to the holding portion 71, and the first support portion 75 are formed to be farthest from the holding portion 71. The slanting portion 77 is formed between the first support portion 75 and the second support portion 76.

The first support portion 75 and the second support portion 76 are in direct contact with the lamp 80, and the lamp 80 is fixed by the first support portion 75 and the second support portion 76. That is to say, a bottom portion of the conductive coating portion 83 of the lamp 80 directly contacts the second support portion 76, and a top portion of the conductive coating portion 83 contacts the first support portion 75. In such a manner, the lamp 80 is securely fixed in place by the lamp socket 70.

The first support portion 75 and the second support portion 76 may be gently curved along the curved surface of the lamp 80. As shown in FIG. 2, the first support portion 75 and the second support portion 76 may be formed to include fixing protrusions 75a, 75b, 76a and 76b. In other words, in order to facilitate fixing of the lamp 80, a first fixing protrusions 75a and 75b may be formed at the first support portion 75, and a second fixing protrusions 76a and 76b may be formed at the second support portion 76. One or more of the first fixing protrusions 75a and 76b and the second fixing protrusions 76a and 76b may be formed, respectively, when necessary. As described above, even if a displacement occurs at the contact surface of the lamp 80 with the lamp socket 70, contact efficiency between the lamp 80 and the lamp socket 70 can be enhanced by forming the first fixing protrusions 75a and 75b, and the second fixing protrusions 76a and 76b at the first support portion 75 and the second support portion 76, respectively.

The first support portion 75 may be formed to have a width greater than a diameter of the lamp 80, and the second support portion 76 may be formed to have a width smaller than the diameter of the lamp 80. Accordingly, the lamp insertion hole 74 has a cross-sectional width gradually decreasing toward the lower portion of the holding portion 71.

A pair of slanting portion 77 may be formed between the first support portion 75 and the second support portion 76, so that the first support portion 75 and the second support portion 76 are gently connected to each other (cf. FIGS. 2 and 3). Here, the slope of the slanting portions 77 may have a gently curved shape. However, the shape of the slanting portions 77 is not necessarily limited to the gently curved shape, but the slanting portions 77 may be shaped of a combination of straight and curved lines to have a gentle slope ranging from the first support portions 75 to the second support portions 76.

When the lamp 80 has a diameter of, for example, 4 mm, the width of the first support portions 75 may be about 4.2 mm and the width of the second support portions 76 may be about 2 mm. That is to say, the first support portions 75 and the second support portions 76 may have a width ratio of about 2:1.

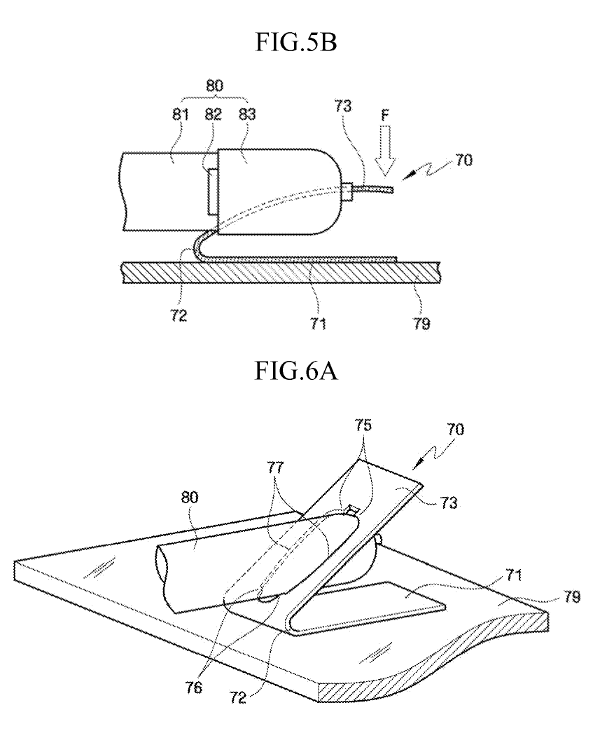

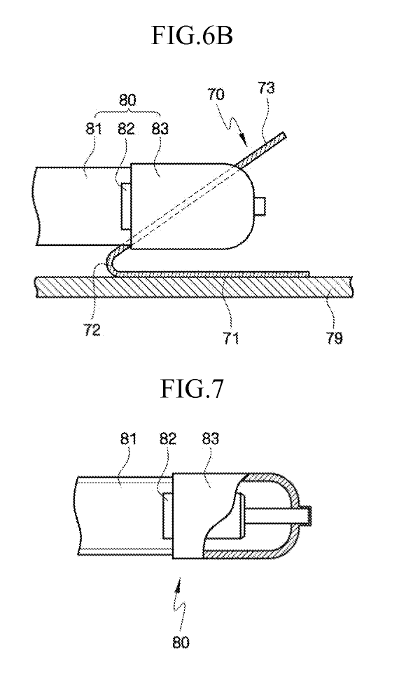

Hereinafter, a process of inserting the lamp 80 into the lamp socket 70 will be described in detail with reference to FIGS. 5A through 6B. FIGS. 5A through 6B are a perspective view and a cross-sectional view illustrating a process of inserting a lamp into a lamp socket.

First, referring to FIGS. 5A and 5B, an external force, F, is applied to the terminal portion 73, and the lamp 80 is then inserted into the terminal portion 73.

In detail, the external force is applied downwards to the terminal portion 73 of the lamp socket 70 attached to the board 79. Here, the terminal portion 73, deforms downwards; that is, droops due to the external force, F.

If the external force is applied to the terminal portion 73, some of the external force, F, deforms the elastic portion 72 and the rest of the external force, F, causes the terminal portion 73 to droop downwards. Here, the lamp insertion hole 74 formed at the terminal portion 73 may deform such that its opening area becomes substantially parallel with the holding portion 71.

When the terminal portion 73 deforms, due to the external force, F, applied thereto, the lamp 80 is inserted downwards. The lamp 80 moves downwards to be parallel with the holding portion 71, and the conductive coating portion 83 is positioned in the lamp insertion hole 74. Here, the lamp 80 comes into contact with the second support portions 76.

Referring to FIGS. 6A and 6B, the external force, F, applied to terminal portion 73 is removed.

In detail, if the external force, F, applied to terminal portion 73 is eliminated after the lamp 80 is positioned in the lamp insertion hole 74, the deformed terminal portion 73 is restored to have its original shape. Here, the second support portions 76 of the lamp insertion hole 74 support the lamp 80 from its lower portion and apply a force that pushes the lamp 80 upwards.

The first support portions 75 come into contact with the top portion of the lamp 80, thereby supporting the lamp 80, which is pushed upwards by means of the second support portions 76. Accordingly, the lamp 80 is securely fixed in place by being pressed downwards and upwards by means of the first support portions 75 and the second support portions 76, respectively.

FIG. 7 is a partly cut-away view of the lamp included in the display device shown in FIG. 1.

The lamp 80 includes a lamp tube 81, a lamp electrode 82, and the conductive coating portion 83.

The lamp tube 81 is shaped in the form of a hollow pipe having a perforated space inside. The thus-shaped lamp tube 81 may be formed of a transparent material, such as glass, to allow the light that is generated inside the lamp tube 81 to be emitted outside. A discharge gas for light emission is injected into the lamp tube 81. Examples of the discharge gas that can be filled in the internal space include mercury (Hg), neon (Ne), xenon (Xe), argon (Ar). Other discharge gases and mixtures of gases thereof may be used, as realized by one of ordinary skill in the art. A voltage difference applied to the lamp electrodes 82 initiates the ionization of the gas inside the lamp 80. The gases in the lamp which are ionized generate ultraviolet light when the ionized atoms decay from an excited state. In addition, the secondary electrons generated by the ionization initiate a cascade event that induces further ionization of the light-emitting gas. An increase of the effective ionization rate of the gas can be obtained by mixing such gas with a small proportion of foreign meta-stable atoms from a different gas, such that the meta-stable energy level of the foreign gas is greater than the ionization potential of the UV-emitting gas. Thus, collisions between the meta-stable atoms and the UV-emitting gas atoms ionize the latter, increasing the amount of ultraviolet light generated, without the need s to increase the voltage level of the discharge. This is a well known effect in the art, namely, the Penning effect. Thus, a decrease in the power consumption of the lamp 80 is obtained.

A fluorescent layer (not shown) is on an internal surface of the lamp tube 81. The fluorescent layer (not shown) is excited by the ultraviolet light that is generated using the discharge gas and emits visible light. The discharge gas in the lamp tube 81 causes a plasma discharge when a driving voltage is applied to the lamp electrode 82, thereby emitting the ultraviolet light.

The lamp tube 81 includes the lamp electrode 82 on its end portions. A driving voltage is applied to the lamp electrode 82 to cause a plasma discharge. The lamp electrode 82 may be formed of a metal, such as nickel (Ni), molybdenum (Mo), or niobium (Nb). One end of the lamp electrode 82 protrudes toward the outside of the lamp tube 81 to then be connected to the conductive coating portion 83 surrounding the one end of the lamp 80. The conductive coating portion 83 is formed by coating a conductive material on opposite ends of the lamp 80, to connect the lamp electrode 82.

That is to say, the conductive coating portion 83 is formed such that the lamp electrode 82, which is inserted into the lamp tube 81 is electrically connected to the lamp socket 70. A conductive material, such as lead (Pb), is coated to the opposite ends of the lamp 80. In general, the conductive material, such as lead (Pb), is easily coated on a metal, such as the lamp electrode 82. In contrast, it is not easy to coat the conductive material, such as lead (Pb), on such a material as glass, in the lamp tube 81.

The conductive material, such as lead (Pb), is coated on the opposite ends of the lamp tube 81 in the following manner First, the lamp tube 81 is placed in the presence of acid and is then coated with a conductive material. Alternatively, a conductive material may be coated on the lamp 81 by dipping the lamp 81 into a soldering solution while applying ultrasonic waves to the lamp tube 81.

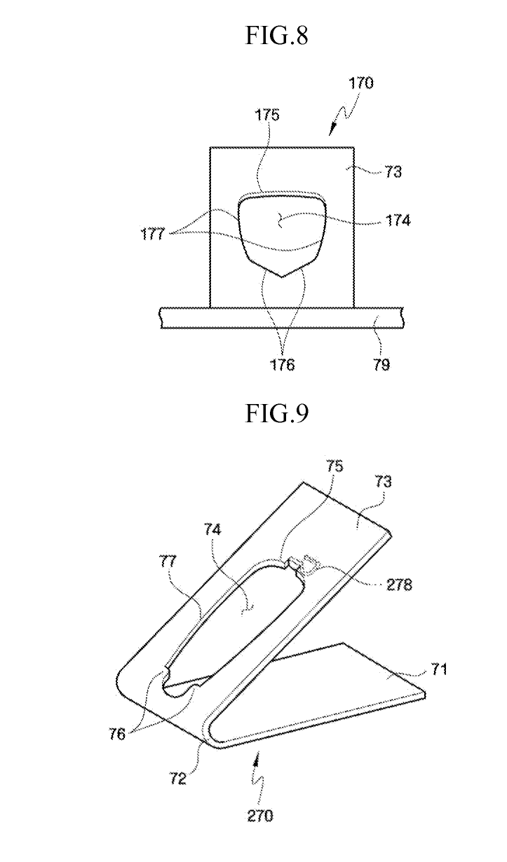

Hereinafter, a display device according to a second exemplary embodiment of the present invention will be described with reference to FIG. 8. FIG. 8 is an exploded perspective view, illustrating a lamp socket and a substrate included in a display device according to a second exemplary embodiment of the present invention. For convenience of description, components having the same function for describing the first embodiment are respectively identified by the same reference numerals. Thus, repetitive descriptions of the same or like elements will not be given or will be simplified below. Only the lamp socket, which is a distinctive component of the current embodiment, will be described.

Referring to FIGS. 2 and 8, the lamp socket 170 included in the display device, according to the second exemplary embodiment of the present invention, is substantially the same as the lamp socket shown in FIG. 2, except for the shape of the lamp insertion hole 174.

The lamp socket 170 includes a holding portion 71, a terminal portion 73, an elastic portion 72, a lamp insertion hole 174, a support portion 175, a pair of first slanting portions 177, and a pair of second slanting portions 176. The holding portion 71 and the elastic portion 72 are not shown in FIG. 8, but can be seen in FIG. 2.

The terminal portion 73 is electrically connected to the lamp electrode 82 formed at one end of each of the lamps 80, and supplies the lamps 80 with power. A lamp insertion hole 174 into which the lamp 80 is inserted to then be fixed, is formed at the terminal portion 73. The terminal portion 73 is connected to the holding portion 71 by the elastic portion 72.

The lamp insertion hole 174 forms a closed curve having a cross-sectional width gradually decreasing toward the holding portion 71. The lamp insertion hole 174 is defined by the support portion 175, the first slanting portions 177 and the second slanting portions 176, by which the lamp insertion hole 174 is encircled. In detail, the support portion 175 of the lamp insertion hole 174 is formed at an area farthest from the holding portion 71. The first slanting portions 177 are formed to be closer to the holding portion 71 from opposite sides of the support portion 175.

The second slanting portions 176 extend from the first slanting portions 177, and end portions of the second slanting portions 176 are connected to each other. Here, an angle formed between the second slanting portions 176 is greater than an angle formed between the first slanting portions 177.

The support portion 175 and the first slanting portions 177 directly contact the lamp 80. The lamp 80 is fixed by the fixing portion 175 and the first slanting portions 177. That is to say, a lower portion of the conductive coating portion 83 of the lamp 80 comes into contact with the second slanting portions 176, and a top portion of the conductive coating portion 83 comes into contact with the support portion 175, thereby allowing the lamp 80 to be fixed to the lamp socket 170. Here, contact efficiency between the lamp 80 and the lamp socket 170 can be enhanced by adjusting the angle formed between the second slanting portions 176.

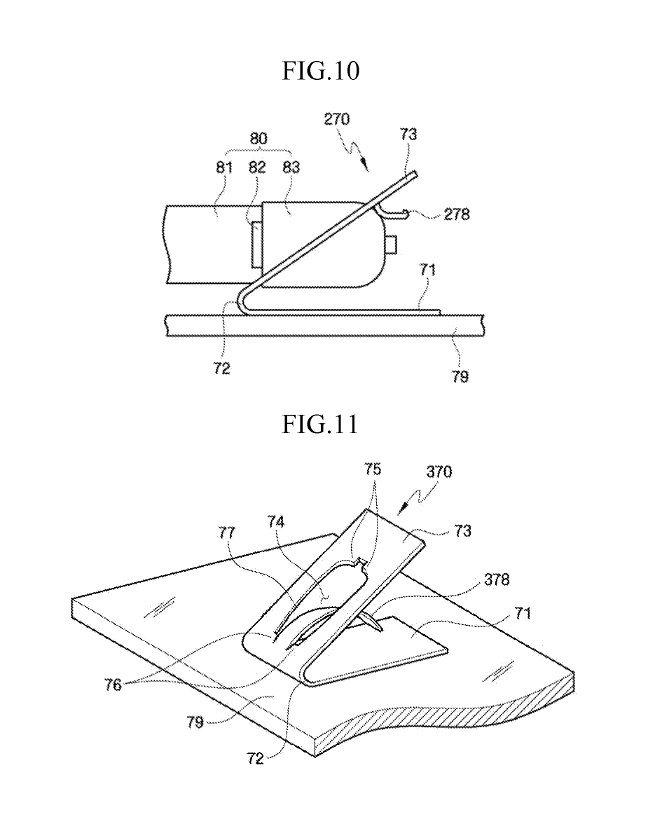

Hereinafter, a display device according to a third exemplary embodiment of the present invention will be described with reference to FIGS. 9 and 10. FIG. 9 is an exploded perspective view illustrating a lamp socket and a substrate included in a display device according to a third exemplary embodiment of the present invention, and FIG. 10 is a side view illustrating the lamp socket in FIG. 9. For convenience of description, components each having the same function for describing the first embodiment are respectively identified by the same reference numerals. Thus, repetitive descriptions of the same or like elements will not be given or will be simplified below. Only the lamp socket, which is a distinctive component of the current embodiment, will be described.

The lamp socket 270 included in the display device according to the third exemplary embodiment of the present invention, includes a stopper 278 for preventing a displacement of the lamp 80.

The stopper 278 extends from first support portions 75 of a terminal portion 73 towards a holding portion 71. The stopper 278 prevents the lamp 80 inserted into the lamp insertion hole 74 from deviating or moving in a lengthwise direction of the lamp 80. The stopper 278 is formed by bending one end of the terminal portion 73 so as to have a predetermined magnitude of elasticity. The stopper 278 reduces a probability of the lamp 80 being displaced due to mechanical shock.

Meanwhile, since the stopper 278 has elasticity, the lamp 80 can be more securely fixed when applying an external force to a top portion of the lamp 80.

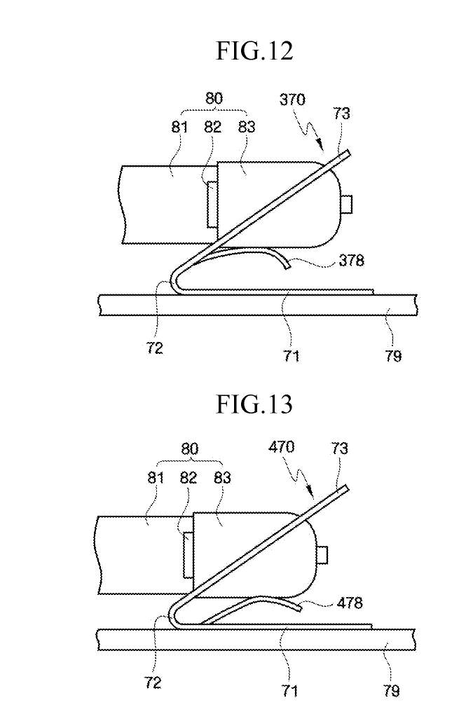

Hereinafter, a display device according to a fourth exemplary embodiment of the present invention will be described with reference to FIGS. 11 and 12. FIG. 11 is an exploded perspective view illustrating a lamp socket and a substrate included in a display device according to a fourth exemplary embodiment of the present invention, and FIG. 12 is a side view illustrating the lamp socket in FIG. 11. For convenience of description, components having the same function for describing the first embodiment are respectively identified by the same reference numerals. Thus, repetitive descriptions of the same or like elements will not be given or will be simplified below. Only the lamp socket, which is a distinctive component of the current embodiment, will be described.

The lamp socket 370 included in the display device according to the fourth exemplary embodiment of the present invention, includes an elastic member 378 that exerts a fixing force on the lamp 80.

The elastic member 378 may extend from a pair of second support portions 76. The elastic member 378 may also be formed by bending one end of a terminal portion 73.

The elastic member 378 is formed by bending one end of the terminal portion 73 so as to have a predetermined magnitude of elasticity, and supports a lower portion of the lamp 80. That is to say, the elastic member 378 prevents the lamp 80 from being displaced from a lamp insertion hole 74 by applying an external force to the lower portion of the lamp 80.

FIG. 13 is a side view illustrating a lamp socket and a substrate included in a display device according to a fifth exemplary embodiment of the present invention.

The lamp socket 470 included in the display device according to the fifth exemplary embodiment of the present invention is a modified example of the lamp socket shown in FIGS. 11 and 12.

In the lamp socket 470, an elastic member 478 is formed by bending one end of a holding portion 71. The elastic member 478 is shaped such that it is bent so as to have elasticity enough to support a lower portion of a lamp 80.

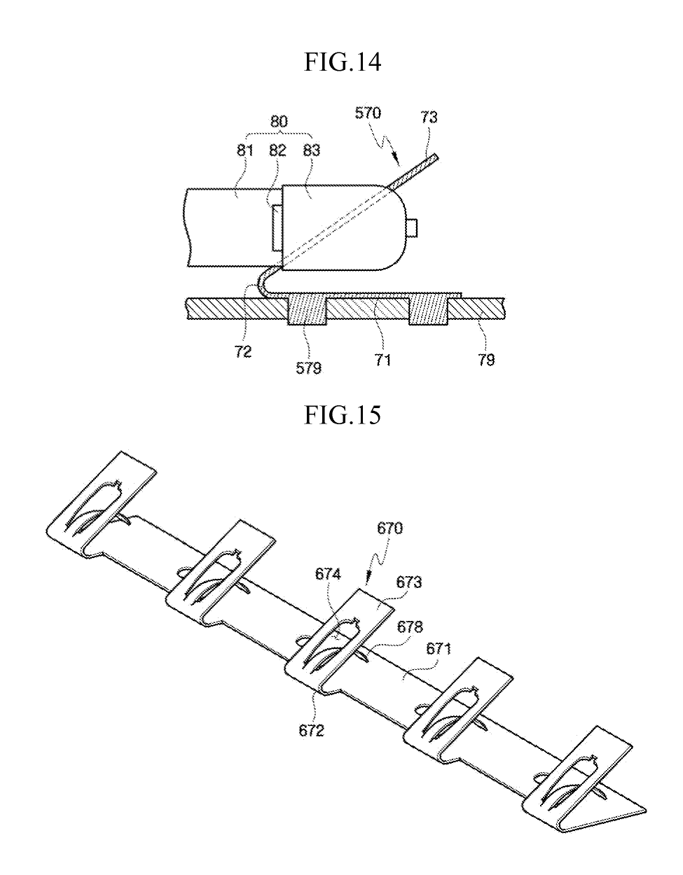

FIG. 14 is a side view illustrating a lamp socket and a substrate included in a display device according to a sixth exemplary embodiment of the present invention.

The lamp socket 570 included in the display device according to the sixth exemplary embodiment of the present invention includes a fixing pin 579 passing through a board 79 to then firmly secure the lamp socket 570 to the board 79.

The lamp socket 570 includes a holding portion 71, an elastic portion 72, and a terminal portion 73. The fixing pin 579 is formed at one side of the holding portion 71. The fixing pin 579 protrudes toward a lower portion of the holding portion 71 and passes through the board 79 to then be fixed.

The fixing pin 579 serves as a connecting electrode that is connected to the lower portion of the board 79. A power source connected to the lower portion of the board 79 may be connected to the terminal portion 73 through the fixing pin 579.

Hereinafter, a display device according to a seventh exemplary embodiment of the present invention will be described with reference to FIG. 15. FIG. 15 is a perspective view illustrating a lamp socket and a substrate included in a display device according to a seventh exemplary embodiment of the present invention. For convenience of description, components having the same function for describing the first embodiment are respectively identified by the same reference numerals. Thus, repetitive descriptions of the same or like elements will not be given or will be simplified below. Only the lamp socket, which is a distinctive component of the current embodiment, will be described.

The lamp socket 670 included in the display device according to the seventh exemplary embodiment of the present invention includes a plurality of terminal portions 673, integrally formed with a single holding portion 671.

In the lamp socket 670, the holding portion 671 is formed to have a relatively large width. A plurality of terminal portions 673 extend from one edge of the holding portion 671. Each of the terminal portions 673 and the holding portion 671 may be formed by bending a single metal sheet.

A lamp insertion hole 674 and an elastic member 678 may be formed at each of the terminal portions 673.

The plurality of terminal portions 673 are connected to the holding portion 671, thereby allowing a plurality of lamps (80 of FIG. 1) to be connected to the lamp socket 670. Accordingly, the same level of driving voltage can be simultaneously applied to the plurality of lamps 80. The lamp socket 670 can be used as a ground socket directly connected to a bottom receiving container (90 of FIG. 1).

While the present invention has been particularly shown and described with reference to exemplary embodiments thereof, it will be understood by those of ordinary skill in the art that various changes in form and details may be made therein, without departing from the spirit and scope of the present invention as defined by the following claims. It is therefore desired that the present embodiments be considered in all respects as illustrative and not restrictive, reference being made to the appended claims rather than the foregoing description, to indicate the scope of the invention.

What is claimed is:

1. A lamp socket comprising:
a holding portion mounted on a board; and
a terminal portion forming an angle with the holding portion and having a lamp insertion hole into which a lamp is inserted, wherein the lamp insertion hole is formed through the terminal portion and has widths gradually decreasing toward a lower portion of the terminal portion.

2. The lamp socket of claim 1, wherein the lamp socket includes a first support portion forming one end of the lamp insertion hole and being in contact with a top portion of the lamp, and a second support portion contacting a bottom portion of the lamp, and a width of the first support portion is greater than that of the second support portion.

3. The lamp socket of claim 2, wherein the first support portion has a width greater than a diameter of the lamp, and the second support portion has a width smaller than the diameter of the lamp.

4. The lamp socket of claim 2, wherein a distance between the first support portion and the second support portion is greater than the diameter of the lamp.

5. The lamp socket of claim 2, wherein the first support portion further includes a first fixing protrusion extending toward the lamp.

6. The lamp socket of claim 2, wherein the second support portion further includes a second fixing protrusion extending toward the lamp.

7. The lamp socket of claim 2, wherein the lamp insertion hole includes a pair of first slanting portions connecting the first support portion and the second support portion.

8. The lamp socket of claim 7, wherein the lamp insertion hole includes a pair of second slanting portions extending from the first slanting portions, the second slanting portions having both end portions connected to each other, and an angle formed between the second slanting portions is greater than an angle formed between the first slanting portions.

9. The lamp socket of claim 2, further comprising a stopper extending from the first support portion towards the holding portion to support the end portions of the lamp.

10. The lamp socket of claim 2, further comprising an elastic portion extending from the second support portion or from the holding portion and applying a restoring force to the lamp.

11. The lamp socket of claim 1, wherein one or more of the terminal portions extending from the holding portion are formed.

12. The lamp socket of claim 1, wherein the holding portion and the terminal portion form an acute angle therebetween.

13. The lamp socket of claim 12, wherein the holding portion and the terminal portion are connected to each other by a curved elastic portion.

14. The lamp socket of claim 1, wherein the lamp includes a lamp tube, a lamp electrode formed at opposite ends of the lamp tube, and a conductive coating portion connected to the lamp electrode, wrapping the opposite ends of the lamp tube.

15. The lamp socket of claim 14, wherein the conductive coating portion is formed by coating the lamp with a conductive material by dipping the lamp into a soldering solution while applying ultrasonic waves to the lamp tube.

16. A display device comprising:
a backlight assembly including:
a board;
a lamp socket including a holding portion mounted on the board, and a terminal portion forming an angle with the holding portion and having a lamp insertion hole; and
a lamp inserted into the lamp insertion hole; and
a display panel receiving light from the lamp to display an image,
wherein the lamp insertion hole is formed through the terminal portion and has a cross-sectional width gradually decreasing toward a lower portion of the terminal portion.

17. The display device of claim 16, wherein the lamp socket includes a first support portion forming one end of the lamp insertion hole and being in contact with a top portion of the lamp, and a second support portion contacting a top portion of the lamp, and a width of the first support portion is greater than that of the second support portion.

18. The display device of claim 17, wherein the first support portion has a width greater than a diameter of the lamp, and the second support portion has a width smaller than the diameter of the lamp.

19. The display device of claim 17, further comprising a stopper extending from the first support portion towards the holding portion to support the end portions of the lamp.

20. The display device of claim 17, wherein one or more of the terminal portions extending from the holding portion are formed.
